(19) United States
(12) Patent Application Publication
(10) Pub. No.: US 2013/0238450 A1
(43) Pub. Date: Sep. 12, 2013

(54) SYSTEM AND METHOD FOR FACILITATING ECONOMIC INVESTMENTS THROUGH SOCIAL INTERACTIONS

(71) Applicant: Ryan Steelberg, Irvine, CA (US)

(72) Inventor: Ryan Steelberg, Irvine, CA (US)

(21) Appl. No.: 13/605,378

(22) Filed: Sep. 6, 2012

Related U.S. Application Data
(60) Provisional application No. 61/531,707, filed on Sep. 7, 2011.

(51) Int. Cl. G06Q 30/02

(52) U.S. Cl. CPC G06Q 30/0276
USPC 705/14.72

(57) ABSTRACT

The present invention provides a computer-implemented system for generating product endorsements, comprising a graphical user interface capable of querying at least one endorsement requester for the product information comprising at least product use information, target demographics information, and product origin information; a remote query engine capable of querying third party advisors on a network for product-related information related to a product indicated by the product information; at least one network port capable of remotely receiving via the network the product information from said graphical user interface, and the product-related information related to the product from the third-party advisors; at least one rules engine communicatively connected to said at least one network port, and comprising a plurality of rules to generate at least a tiered one of the product endorsements of a product responsively to the product information and the third party advisors information.

### CROSS-REFERENCE TO RELATED APPLICATION

This application claims the benefit of priority from U.S. Provisional Application Ser. No. 61/531,707, filed Sep. 7, 2011, the entirety of which is expressly incorporated herein by reference in its entirety.

### FIELD OF THE INVENTION

The present invention relates to providing access and a forum for allowing investment in companies, and, more particularly, to system and method for facilitating economic investments through social interactions.

### SUMMARY OF THE INVENTION

The present invention may enable about 3-5 companies, per show/program, whether shown via the internet, podcast or other transfer medium, to pitch their company/idea/product/service to 3-5 popular national or local celebrities to endorse their products.

The present invention provides a computer-implemented system for generating product endorsements, comprising a non-transitory computer readable storage medium having encoded thereon computer executable instructions for providing a graphical user interface capable of querying at least one endorsement requester for the product information comprising at least product use information, target demographics information, and product origin information; a remote query engine capable of querying third party advisors on a network for product-related information related to a product indicated by the product information; at least one network port capable of remotely receiving via the network the product information from said graphical user interface, and the product-related information related to the product from the third-party advisors; at least one rules engine communicatively connected to said at least one network port, and comprising a plurality of rules to generate at least a tiered one of the product endorsements of a product responsively to the product information and the third party advisors information; and a reporting engine capable of providing local delivery to the endorsement requester of the tiered endorsements.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods; and

FIG. 2 is a block diagram showing an exemplary networked computing environment for use in accordance with herein described systems and methods.

### DETAILED DESCRIPTION

A computer-implemented platform and methods of use are disclosed that provide networked access to a plurality of types of digital content, including but not limited to video, audio, and document content, that may allow for social interaction with companies and ideas from those companies, such as via one or more applications, or “apps.” Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

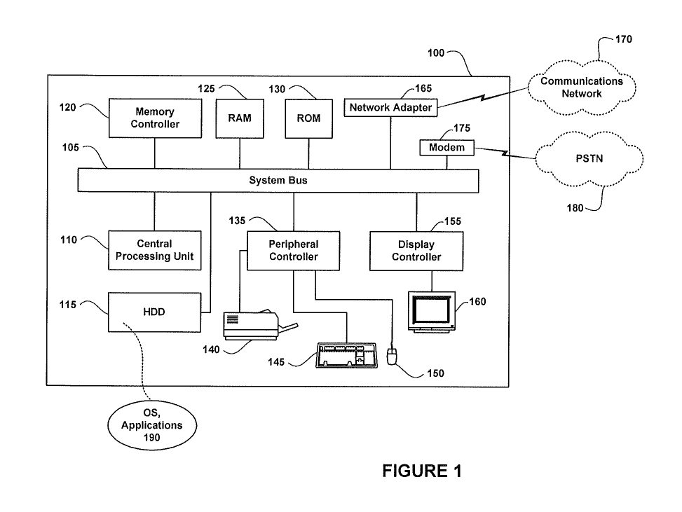

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

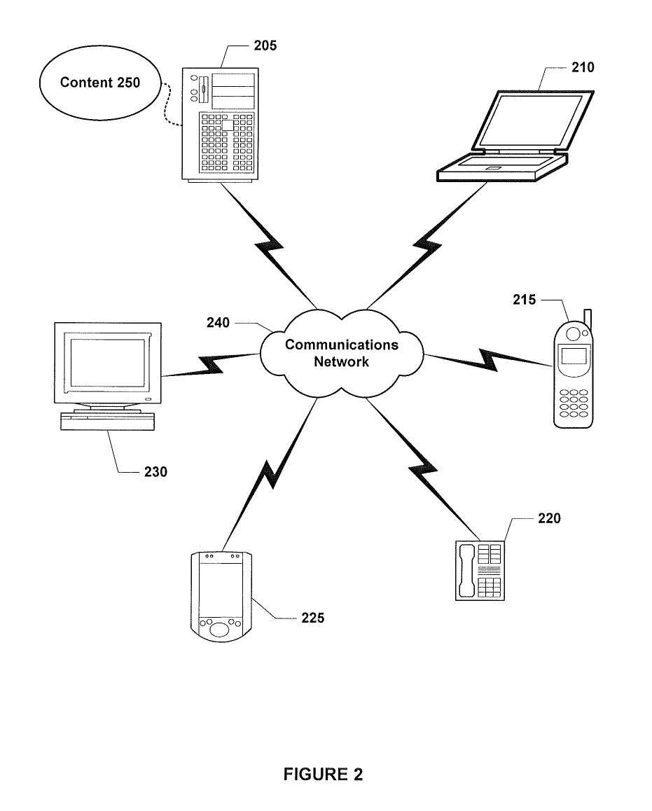

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

In an embodiment of the present invention, a user may access the present invention through a GUI and participate in the funding of a participating company or individual, such as, for example, providing a start-up and/or series A invested companies with source and/or seed capital, angel capital, or other forms of direct investment.

The present invention may enable about 3-5 companies, per show/program, whether shown via the internet, podcast or other transfer medium, to pitch their company/idea/product/service to 3-5 popular national or local celebrities to endorse their products.

The present invention may provide access to personal advisers whom may test each product and service, and may have about 24-48 hours to maker a decision to endorse each product. Personal advisors, or other designated personnel, may only choose one or more companies, but each company may only have one personal advisor. For example, if all three stars want the same company, they must fight it out; and fans, or other participants who are interactively coupled to the present invention, may choose to select the best fit.

Such participants may call in, text, Tweet, or post via Facebook or other social medium, in their favorite company.

Participating companies may, before their sign up for “show”, may be required to agree to that if they are selected by one, or more celebrities, their must provide a percentage of equity in the company to the star; and star will sign a minimum of 1 year endorsement contract with each company. The company that WINS will get $250K marketing budget (which may be managed by a third party), and the selected star will get a percentage of equity, like, for example, a 10% stake and cash compensation, like, for example, $50,000.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented system for generating product endorsements, comprising:
a non-transitory computer readable storage medium having encoded thereon computer executable instructions for providing a graphical user interface capable of querying at least one endorsement requester for the product information comprising at least product use information, target demographics information, and product origin information;
a remote query engine capable of querying third party advisors on a network for product-related information related to a product indicated by the product information;
at least one network port capable of remotely receiving via the network the product information from said graphical user interface, and the product-related information related to the product from the third-party advisors;
at least one rules engine communicatively connected to said at least one network port, and comprising a plurality of rules to generate at least a tiered one of the product endorsements of a product responsively to the product information and the third party advisors information; and
a reporting engine capable of providing local delivery to the endorsement requester of the tiered endorsements.

2. The system of claim 1, wherein the endorsement requester designates at least one third party advisor.

3. The system of claim 1, wherein the third party advisors information further comprises social media input from at least one additional third party.
